(19) United States
(12) Patent Application Publication
(10) Pub. No.: US 2019/0204841 A1
(43) Pub. Date: Jul. 4, 2019

(54) SYSTEMS AND METHODS FOR PATH DETERMINATION

(71) Applicant: BEIJING DIDI INFINITY TECHNOLOGY AND DEVELOPMENT CO., LTD., Beijing (CN)

(72) Inventor: Wei LUO, Beijing (CN)

(73) Assignee: BEIJING DIDI INFINITY TECHNOLOGY AND DEVELOPMENT CO,, LTD., Beijing (CN)

(21) Appl. No.: 16/236,281

(22) Filed: Dec. 28, 2018

Related U.S. Application Data
(63) Continuation of application No. PCT/CN2017/120190, filed on Dec. 29, 2017.

(51) Int. Cl. G05D 1/02; G05D 1/00; B60W 50/00

(52) U.S. Cl. CPC G05D 1/0214; G05D 1/0088; G05D 2201/0213; B60W 2050/0019; B60W 2550/10; B60W 50/00

(57) ABSTRACT

Systems and methods for path determination are provided. The system, comprise a mounting structure configured to mount on a vehicle; and a control module attached on the mounting structure. The control module includes at least one storage medium storing a set of instructions, an output port, and, a microchip in connection with the storage medium, wherein during operation, the microchip executing the set of instructions to: obtain vehicle status information; determine a reference path based on vehicle status information; determine a loss function incorporating the reference path, vehicle status information, and a candidate path; obtain an optimized candidate path by optimizing the loss function; send an electronic signal encoding the optimized candidate path to the output port.

### TECHNICAL FIELD

This present disclosure generally relates to systems and methods for path determination, and more particularly, to systems and methods for path determination for an autonomous vehicle.

### BACKGROUND

With the development of cutting-edge technologies such as artificial intelligence (AI), an autonomous vehicle has great prospects for multiple applications, for example, the transportation service. Without human maneuvering, it is challenging for the autonomous vehicle to drive safely. Therefore, it is important to determine an optimal path for the autonomous vehicle to follow such that the autonomous vehicle reaches the destination safely.

### SUMMARY

According to an aspect of the present disclosure, a system is provided. The system may include a mounting structure configured to mount on a vehicle and a control module attached on the mounting structure. The control module may include at least one storage medium, an output port, and a microchip in connection with the storage medium, the microchip may execute one or more of the following operations. The microchip may obtain vehicle status information. The microchip may determine a reference path based on the vehicle status information. The microchip may determine a loss function incorporating the reference path, vehicle status information, and a candidate path. The microchip may obtain an optimized candidate path by optimizing the loss function. The microchip may send an electronic signal encoding the optimized candidate path to the output port.

In some embodiments, the system further include a Gateway Module (GWM) electronically connected the control module to a Control Area Network (CAN). The CAN may be electrically connected the GWM to at least one of an Engine Management System (EMS), an Electric Power System (EPS), an Electric Stability Control (ESC), and a Steering Column Module (SCM).

In some embodiments, the reference path may include a reference sample, the candidate path may include a candidate sample, and the evaluation function may include a first indicator. The control module may further determine the first indicator based on a difference between a reference location of the reference sample and a candidate location of the candidate sample.

In some embodiments, the reference path may include a reference sample, the candidate path may include a candidate sample, and the evaluation function may include a second indicator. The control module may further determine the second indicator based on a difference between a reference velocity of the reference sample and a candidate velocity of the candidate sample.

In some embodiments, the reference path may include a reference sample, the candidate path may include a candidate sample, and the evaluation function may include a third indicator. The control module may further determine the third indicator based on a difference between a reference acceleration of the reference sample and a candidate acceleration of the candidate sample.

In some embodiments, the evaluation function may include a fourth indicator. The control module may further obtain profile data of the vehicle. The control module may further obtain one or more locations of one or more obstacles around the vehicle. The control module may further determine one or more obstacle distances between the vehicle and the one or more obstacles. The control module may further determine the fourth indicator based on the one or more obstacle distances.

In some embodiments, value of the fourth indicator may be inversely proportional to the one or more obstacle distances.

In some embodiments, the fourth indicator may be expressed as:

$${\sum }_{k = 1}^{M} \frac{1}{{d}_{k} + E}$$

wherein the dₖ denotes the one or more obstacle distance, M denotes number of the one or more obstacles, and E denotes the profile data.

In some embodiments, the vehicle status information may include at least one of a driving direction of the vehicle, a velocity of the vehicle, an acceleration of the vehicle, or environment information around the vehicle.

In some embodiments, the loss function may be optimized by gradient descent method.

According to another aspect of the present disclosure, a method is provided. The method may be implemented on a control module, having a microchip, a storage medium, and an output, attached on a mounting structure of a vehicle. The method may include obtaining status information of a vehicle. The method may include determining a reference path based on the vehicle status information. The method may further include determining a loss function incorporating the reference path, vehicle status information, and a candidate path. The method may further include obtaining an optimized candidate path by optimizing the loss function. The method may further include sending an electronic signal encoding the optimized candidate path to the output port.

According to another aspect of the present disclosure, a non-transitory computer readable medium is provided. The non-transitory computer readable medium may comprise at least one set of instructions for determining a path for a vehicle. When executed by at least one processor of an electronic terminal, the at least one set of instructions may direct the at least one processor to perform acts of: obtaining vehicle status information; determining a reference path based on vehicle status information; determining a loss function incorporating the reference path, vehicle status information, and a candidate path; obtaining an optimized candidate path by optimizing the loss function; sending an electronic signal encoding the optimized candidate path to the output port.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a schematic diagram illustrating an exemplary scenario for autonomous vehicle according to some embodiments of the present disclosure;

FIG. 2 is a block diagram of an exemplary vehicle with an autonomous driving capability according to some embodiments of the present disclosure;

FIG. 3 is a schematic diagram illustrating exemplary hardware and software components of a information processing unit according to some embodiments of the present disclosure;

FIG. 4 is a block diagram illustrating an exemplary control unit according to some embodiments of the present disclosure;

FIG. 5 is a block diagram illustrating a path planning module according to some embodiments of the present disclosure;

FIG. 6 is a flowchart illustrating an exemplary process and/or method for determining an optimized path according to some embodiments of the present disclosure;

FIG. 7 is a flowchart illustrating an exemplary process and/or method for determining a first indicator according to some embodiments of the present disclosure;

FIG. 8 is a flowchart illustrating an exemplary process and/or method for determining a second indicator according to some embodiments of the present disclosure;

FIG. 9 is a flowchart illustrating an exemplary process and/or method for determining a third indicator according to some embodiments of the present disclosure;

FIG. 10 is a block diagram illustrating an exemplary obstacle indicator determination unit according to some embodiments of the present disclosure;

FIG. 11 is a flowchart illustrating an exemplary process and/or method for determining a fourth indicator according to some embodiments of the present disclosure;

FIG. 12 is a block diagram illustrating an exemplary optimized path determination unit according to some embodiments of the present disclosure; and

FIG. 13 is a flowchart illustrating an exemplary process and/or method for determining an optimized candidate path according to some embodiments of the present disclosure.

### DETAILED DESCRIPTION

The following description is presented to enable any person skilled in the art to make and use the present disclosure, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but is to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

In the present disclosure, the term “autonomous vehicle” may refer to a vehicle capable of sensing its environment and navigating without human (e.g., a driver, a pilot, etc.) input. The term “autonomous vehicle” and “vehicle” may be used interchangeably. The term “autonomous driving” may refer to ability of navigating without human (e.g., a driver, a pilot, etc.) input.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

The flowcharts used in the present disclosure illustrate operations that systems implement according to some embodiments in the present disclosure. It is to be expressly understood, the operations of the flowchart may be implemented not in order. Conversely, the operations may be implemented in inverted order, or simultaneously. Moreover, one or more other operations may be added to the flowcharts. One or more operations may be removed from the flowcharts.

The positioning technology used in the present disclosure may be based on a global positioning system (GPS), a global navigation satellite system (GLONASS), a compass navigation system (COMPASS), a Galileo positioning system, a quasi-zenith satellite system (QZSS), a wireless fidelity (WiFi) positioning technology, or the like, or any combination thereof. One or more of the above positioning systems may be used interchangeably in the present disclosure.

Moreover, while the systems and methods disclosed in the present disclosure are described primarily regarding determining a path of a vehicle (e.g., an autonomous vehicle), it should be understood that this is only one exemplary embodiment. The system or method of the present disclosure may be applied to any other kind of navigation system. For example, the system or method of the present disclosure may be applied to transportation systems of different environments including land, ocean, aerospace, or the like, or any combination thereof. The autonomous vehicle of the transportation systems may include a taxi, a private car, a hitch, a bus, a train, a bullet train, a high-speed rail, a subway, a vessel, an aircraft, a spaceship, a hot-air balloon, a driverless vehicle, or the like, or any combination thereof. In some embodiments, the system or method may find applications in, e.g., logistic warehousing, military affairs.

An aspect of the present disclosure relates to systems and methods for determining a path for a vehicle. To this end, the system may obtain vehicle status information of the vehicle. The system may then determine a reference path based on the vehicle status information, the reference path being a path that an autonomous vehicle would go along without considering an obstacle. The system may further determine one or more candidate paths, the one or more candidate paths being paths that an autonomous vehicle would go along with considering one or more obstacles. In some embodiments, the system may minimize a value associated with the reference path, one of the one or more candidate paths and the one or more obstacles. The value to be minimized may be determined based on kinematic differences between the reference path and a candidate path and distances between an autonomous vehicle driving along the candidate path and the one or more obstacles. The system may minimize the value by updating the candidate path. The system may update the candidate path based on a gradient descent method by updating sample features of the candidate path. The system may determine an updated candidate path as the path for the vehicle when a minimized value is produced based on the updated candidate path.

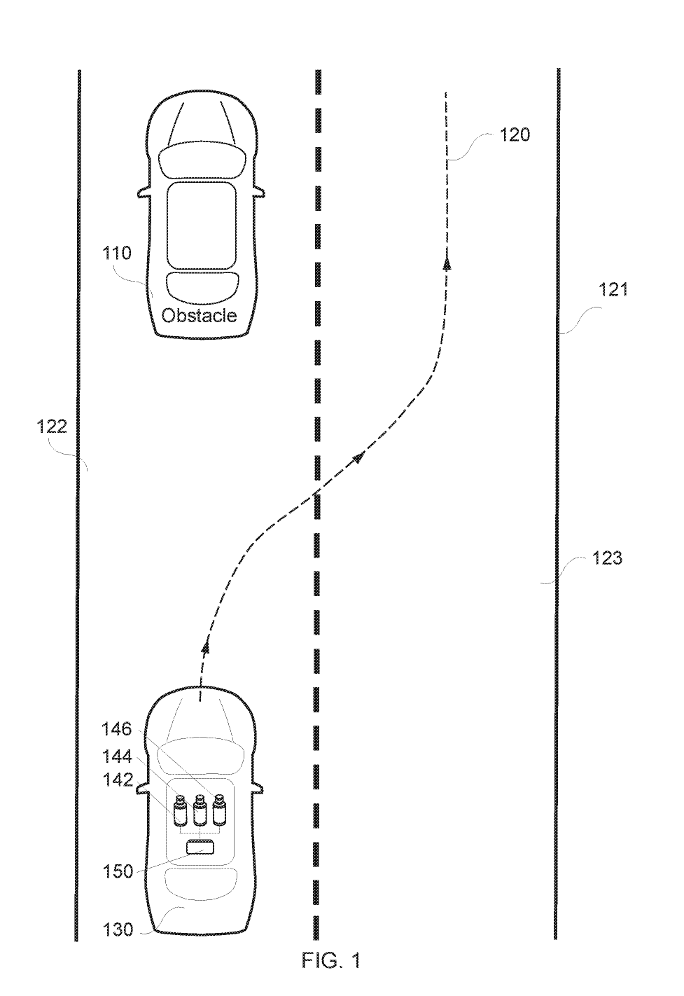

FIG. 1 is a schematic diagram illustrating an exemplary scenario for autonomous vehicle according to some embodiments of the present disclosure. As shown in FIG. 1, an autonomous vehicle 130 may travel along a road 121 without human input along a path autonomously determined by the autonomous vehicle 130. The road 121 may be a space prepared for a vehicle to travel along. For example, the road 121 may be a road for vehicles with wheel (e.g. a car, a train, a bicycle, a tricycle, etc.) or without wheel (e.g., a hovercraft), may be an air lane for an air plane or other aircraft, and may be a water lane for ship or submarine, may be an orbit for satellite. Travel of the autonomous vehicle 130 may not break traffic law of the road 121 regulated by law or regulation. For example, speed of the autonomous vehicle 130 may not exceed speed limit of the road 121. The road 121 may include one or more lanes (e.g., lane 122 and lane 123).

The autonomous vehicle 130 may not collide an obstacle 110 by travelling along a driving path 120 determined by the autonomous vehicle 130. The obstacle 110 may be a static obstacle or a motional obstacle. The static obstacle may include a building, tree, roadblock, or the like, or any combination thereof. The motional obstacle may include moving vehicles, pedestrians, and/or animals, or the like, or any combination thereof.

The autonomous vehicle 130 may include conventional structures of a non-autonomous vehicle, such as an engine, four wheels, a steering wheel, etc. The autonomous vehicle 130 may further include a plurality of sensors (e.g., a sensor 142, a sensor 144, a sensor 146) and a control unit 150. The plurality of sensors may be configured to provide information that is used to control the vehicle. In some embodiments, the sensors may sense status of the vehicle. The status of the vehicle may include dynamic situation of the vehicle, environmental information around the vehicle, or the like, or any combination thereof.

In some embodiments, the plurality of sensors may be configured to sense dynamic situation of the autonomous vehicle 130. The plurality of sensors may include a distance sensor, a velocity sensor, an acceleration sensor, a steering angle sensor, a traction-related sensor, a camera, and/or any sensor.

For example, the distance sensor (e.g., a radar, a LiDAR, an infrared sensor) may determine a distance between a vehicle (e.g., the autonomous vehicle 130) and other objects (e.g., the obstacle 110). The distance sensor may also determine a distance between a vehicle (e.g., the autonomous vehicle 130) and one or more obstacles (e.g., static obstacles, motional obstacles). The velocity sensor (e.g., a Hall effect sensor) may determine a velocity (e.g., an instantaneous velocity, an average velocity) of a vehicle (e.g., the autonomous vehicle 130). The acceleration sensor (e.g., an accelerometer) may determine an acceleration (e.g., an instantaneous acceleration, an average acceleration) of a vehicle (e.g., the autonomous vehicle 130). The steering angle sensor (e.g., a tilt sensor or a micro gyroscope) may determine a steering angle of a vehicle (e.g., the autonomous vehicle 130). The traction-related sensor (e.g., a force sensor) may determine a traction of a vehicle (e.g., the autonomous vehicle 130).

In some embodiments, the plurality of sensors may sense environment around the autonomous vehicle 130. For example, one or more sensors may detect a road geometry and obstacles (e.g., static obstacles, motional obstacles). The road geometry may include a road width, road length, road type (e.g., ring road, straight road, one-way road, two-way road). The static obstacles may include a building, tree, roadblock, or the like, or any combination thereof. The motional obstacles may include moving vehicles, pedestrians, and/or animals, or the like, or any combination thereof. The plurality of sensors may include one or more video cameras, laser-sensing systems, infrared-sensing systems, acoustic-sensing systems, thermal-sensing systems, or the like, or any combination thereof.

The control unit 150 may be configured to control the autonomous vehicle 130. The control unit 150 may control the autonomous vehicle 130 to drive along a driving path 120. The control unit 150 may determine the driving path 120 and speed along the driving path 120 based on the status information from the plurality of sensors. In some embodiments, the driving path 120 may be configured to avoid collisions between the vehicle and one or more obstacles (e.g., the obstacle 110).

In some embodiments, the driving path 120 may include one or more path samples. Each path sample may be a sampled point in the driving path. Accordingly, each path sample may be corresponding to a location in the driving path and a sampling time. Each path sample may include a plurality of sample features. The plurality of sample features may include velocities, accelerations, locations, or the like, or a combination thereof.

The autonomous vehicle 130 may drive along the driving path 120 to avoid a collision with an obstacle. In some embodiments, the autonomous vehicle 130 may pass each path location at a corresponding path velocity and a corresponding path acceleration for each path location.

In some embodiments, the autonomous vehicle 130 may also include a positioning system to obtain and/or determine the position of the autonomous vehicle 130. In some embodiments, the positioning system may also be connected to another party, such as a base station, another vehicle, or another person, to obtain the position of the party. For example, the positioning system may be able to establish a communication with a positioning system of another vehicle, and may receive the position of the other vehicle and determine the relative positions between the two vehicles.

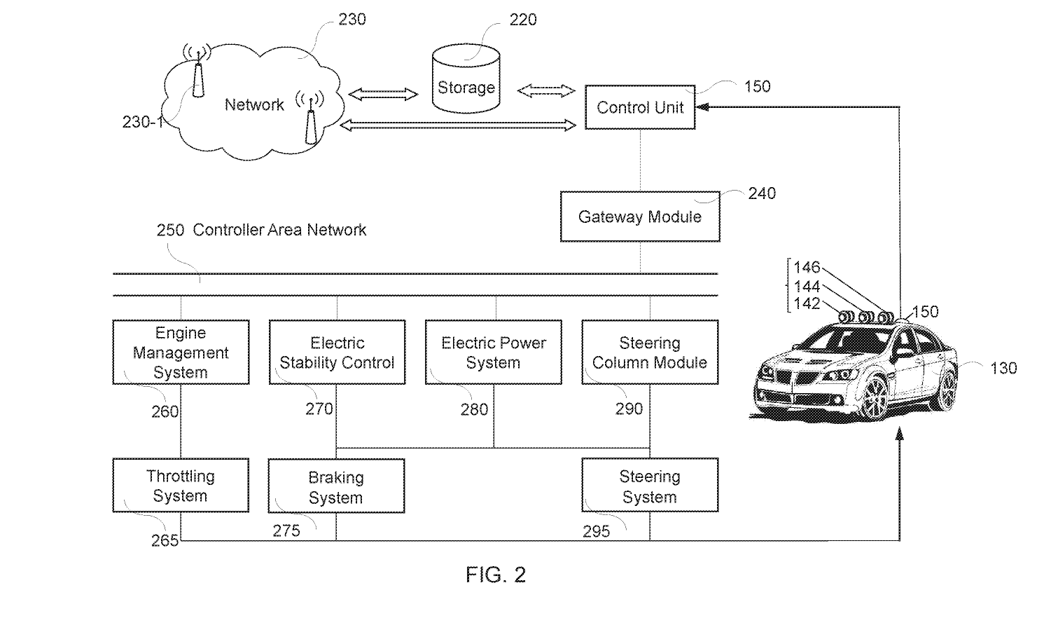

FIG. 2 is a block diagram of an exemplary vehicle with an autonomous driving capability according to some embodiments of the present disclosure. For example, the vehicle with an autonomous driving capability may include a control unit 150, a plurality of sensors 142, 144, 146, a storage 220, a network 230, a gateway module 240, a Controller Area Network (CAN) 250, an Engine Management System (EMS) 260, an Electric Stability Control (ESC) 270, an Electric Power System (EPS) 280, a Steering Column Module (SCM) 290, a throttling system 265, a braking system 275 and a steering system 295.

The control unit 150 may process information and/or data relating to vehicle driving (e.g., autonomous driving) to perform one or more functions described in the present disclosure. In some embodiments, the control unit 150 may be configured to drive a vehicle autonomously. For example, the control unit 150 may output a plurality of control signals. The plurality of control signal may be configured to be received by a plurality of electronic control units (ECUs) to control the drive of a vehicle. In some embodiments, the control unit 150 may determine a reference path and one or more candidate paths based on environment information of the vehicle. In some embodiments, the control unit 150 may include one or more processing engines (e.g., single-core processing engine(s) or multi-core processor(s)). Merely by way of example, the control unit 150 may include a central processing unit (CPU), an application-specific integrated circuit (ASIC), an application-specific instruction-set processor (ASIP), a graphics processing unit (GPU), a physics processing unit (PPU), a digital signal processor (DSP), a field programmable gate array (FPGA), a programmable logic device (PLD), a controller, a microcontroller unit, a reduced instruction-set computer (RISC), a microprocessor, or the like, or any combination thereof.

The storage 220 may store data and/or instructions. In some embodiments, the storage 220 may store data obtained from the autonomous vehicle 130. In some embodiments, the storage 220 may store data and/or instructions that the control unit 150 may execute or use to perform exemplary methods described in the present disclosure. In some embodiments, the storage 220 may include a mass storage, a removable storage, a volatile read-and-write memory, a read-only memory (ROM), or the like, or any combination thereof. Exemplary mass storage may include a magnetic disk, an optical disk, a solid-state drive, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyrisor RAM (T-RAM), and a zero-capacitor RAM (Z-RAM), etc. Exemplary ROM may include a mask ROM (MROM), a programmable ROM (PROM), an erasable programmable ROM (EPROM), an electrically-erasable programmable ROM (EEPROM), a compact disk ROM (CD-ROM), and a digital versatile disk ROM, etc. In some embodiments, the storage may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the storage 220 may be connected to the network 230 to communicate with one or more components of the autonomous vehicle 130 (e.g., the control unit 150, the sensor 142). One or more components in the autonomous vehicle 130 may access the data or instructions stored in the storage 220 via the network 230. In some embodiments, the storage 220 may be directly connected to or communicate with one or more components in the autonomous vehicle 130 (e.g., the control unit 150, the sensor 142). In some embodiments, the storage 220 may be part of the autonomous vehicle 130.

The network 230 may facilitate exchange of information and/or data. In some embodiments, one or more components in the autonomous vehicle 130 (e.g., the control unit 150, the sensor 142) may send information and/or data to other component(s) in the autonomous vehicle 130 via the network 230. For example, the control unit 150 may obtain/acquire dynamic situation of the vehicle and/or environment information around the vehicle via the network 230. In some embodiments, the network 230 may be any type of wired or wireless network, or combination thereof. Merely by way of example, the network 230 may include a cable network, a wireline network, an optical fiber network, a telecommunications network, an intranet, an Internet, a local area network (LAN), a wide area network (WAN), a wireless local area network (WLAN), a metropolitan area network (MAN), a wide area network (WAN), a public telephone switched network (PSTN), a Bluetooth network, a ZigBee network, a near field communication (NFC) network, or the like, or any combination thereof. In some embodiments, the network 230 may include one or more network access points. For example, the network 230 may include wired or wireless network access points such as base stations and/or internet exchange points 230-1, . . . , through which one or more components of the autonomous vehicle 130 may be connected to the network 230 to exchange data and/or information.

The gateway module 240 may determine a command source for the plurality of ECUs (e.g., the EMS 260, the EPS 280, the ESC 270, the SCM 290) based on a current driving status of the vehicle. The command source may be from a human driver, from the control unit 150, or the like, or any combination thereof.

The gateway module 240 may determine the current driving status of the vehicle. The driving status of the vehicle may include a manual driving status, a semi-autonomous driving status, an autonomous driving status, an error status, or the like, or any combination thereof. For example, the gateway module 240 may determine the current driving status of the vehicle to be a manual driving status based on an input from a human driver. For another example, the gateway module 240 may determine the current driving status of the vehicle to be a semi-autonomous driving status when the current road condition is complex. As still another example, the gateway module 240 may determine the current driving status of the vehicle to be an error status when abnormalities (e.g., a signal interruption, a processor crash) occur.

In some embodiments, the gateway module 240 may transmit operations of the human driver to the plurality of ECUs in response to a determination that the current driving status of the vehicle is a manual driving status. For example, the gateway module 240 may transmit a press operation to the accelerator of the vehicle 130 performed by the human driver to the EMS 260 in response to a determination that the current driving status of the vehicle is a manual driving status. The gateway module 240 may transmit control signals of the control unit 150 to the plurality of ECUs in response to a determination that the current driving status of the vehicle is an autonomous driving status. For example, the gateway module 240 may transmit a control signal associated with a steering operation to the SCM 290 in response to a determination that the current driving status of the vehicle is an autonomous driving status. The gateway module 240 may transmit the operations of the human driver and the control signals of the control unit 150 to the plurality of ECUs in response to a determination that the current driving status of the vehicle is a semi-autonomous driving status. The gateway module 240 may transmit an error signal to the plurality of ECUs in response to a determination that the current driving status of the vehicle is an error status.

A Controller Area Network (CAN bus) is a robust vehicle bus standard (e.g., a message-based protocol) allowing microcontrollers (e.g., the control unit 150) and devices (e.g., the EMS 260, the EPS 280, the ESC 270, and/or the SCM 290, etc.) to communicate with each other in applications without a host computer. The CAN 250 may be configured to connect the control unit 150 with the plurality of ECUs (e.g., the EMS 260, the EPS 280, the ESC 270, the SCM 290).

The EMS 260 may be configured to determine an engine performance of the autonomous vehicle 130. In some embodiments, the EMS 260 may determine the engine performance of the autonomous vehicle 130 based on the control signals from the control unit 150. For example, the EMS 260 may determine the engine performance of the autonomous vehicle 130 based on a control signal associated with an acceleration from the control unit 150 when the current driving status is an autonomous driving status. In some embodiments, the EMS 260 may determine the engine performance of the autonomous vehicle 130 based on operations of a human driver. For example, the EMS 260 may determine the engine performance of the autonomous vehicle 130 based on a press on the accelerator done by the human driver when the current driving status is a manual driving status.

The EMS 260 may include a plurality of sensors and at least one micro-processor. The plurality of sensors may be configured to detect one or more physical signals and convert the one or more physical signals to electrical signals for processing. In some embodiments, the plurality of sensors may include a variety of temperature sensors, an air flow sensor, a throttle position sensor, a pump pressure sensor, a speed sensor, an oxygen sensor, a load sensor, a knock sensor, or the like, or any combination thereof. The one or more physical signals may include, but not limited to, an engine temperature, an engine intake air volume, a cooling water temperature, an engine speed, or the like, or any combination thereof. The micro-processor may determine the engine performance based on a plurality of engine control parameters. The micro-processor may determine the plurality of engine control parameters based on the plurality of electrical signals. The plurality of engine control parameters may be determined to optimize the engine performance. The plurality of engine control parameters may include an ignition timing, a fuel delivery, an idle air flow, or the like, or any combination thereof.

The throttling system 265 may be configured to change motions of the autonomous vehicle 130. For example, the throttling system 265 may determine a velocity of the autonomous vehicle 130 based on an engine output. For another example, the throttling system 265 may cause an acceleration of the autonomous vehicle 130 based on the engine output. The throttling system 265 may include fuel injectors, a fuel pressure regulator, an auxiliary air valve, a temperature switch, a throttle, an idling speed motor, a fault indicator, ignition coils, relays, or the like, or any combination thereof.

In some embodiments, the throttling system 265 may be an external executor of the EMS 260. The throttling system 265 may be configured to control the engine output based on the plurality of engine control parameters determined by the EMS 260.

The ESC 270 may be configured to improve the stability of the vehicle. The ESC 270 may improve the stability of the vehicle by detecting and reducing loss of traction. In some embodiments, the ESC 270 may control operations of the braking system 275 to help steer the vehicle in response to a determination that a loss of steering control is detected by the ESC 270. For example, the ESC 270 may improve the stability of the vehicle when the vehicle starts on an uphill slope by braking. In some embodiments, the ESC 270 may further control the engine performance to improve the stability of the vehicle. For example, the ESC 270 may reduce an engine power when a probable loss of steering control happens. The loss of steering control may happen when the vehicle skids during emergency evasive swerves, when the vehicle understeers or oversteers during poorly judged turns on slippery roads, etc.

The braking system 275 may be configured to control a motion state of the autonomous vehicle 130. For example, the braking system 275 may decelerate the autonomous vehicle 130. For another example, the braking system 275 may stop the autonomous vehicle 130 in one or more road conditions (e.g., a downhill slope). As still another example, the braking system 275 may keep the autonomous vehicle 130 at a constant velocity when driving on a downhill slope.

The braking system 275 may include a mechanical control component, a hydraulic unit, a power unit (e.g., a vacuum pump), an executing unit, or the like, or any combination thereof. The mechanical control component may include a pedal, a handbrake, etc. The hydraulic unit may include a hydraulic oil, a hydraulic hose, a brake pump, etc. The executing unit may include a brake caliper, a brake pad, a brake disc, etc.

The EPS 280 may be configured to control electric power supply of the autonomous vehicle 130. The EPS 280 may supply, transfer, and/or store electric power for the autonomous vehicle 130. For example, the EPS 280 may include one or more batteries and alternators. The alternator may be configured to charge the battery, and the battery may be connected to other parts of the vehicle 130 (e.g., a starter to provide power). In some embodiments, the EPS 280 may control power supply to the steering system 295. For example, the EPS 280 may supply a large electric power to the steering system 295 to create a large steering torque for the autonomous vehicle 130, in response to a determination that the autonomous vehicle 130 should conduct a sharp turn (e.g., turning a steering wheel all the way to the left or all the way to the right).

The SCM 290 may be configured to control the steering wheel of the vehicle. The SCM 290 may lock/unlock the steering wheel of the vehicle. The SCM 290 may lock/unlock the steering wheel of the vehicle based on the current driving status of the vehicle. For example, the SCM 290 may lock the steering wheel of the vehicle in response to a determination that the current driving status is an autonomous driving status. The SCM 290 may further retract a steering column shaft in response to a determination that the current driving status is an autonomous driving status. For another example, the SCM 290 may unlock the steering wheel of the vehicle in response to a determination that the current driving status is a semi-autonomous driving status, a manual driving status, and/or an error status.

The SCM 290 may control the steering of the autonomous vehicle 130 based on the control signals of the control unit 150. The control signals may include information related to a turning direction, a turning location, a turning angle, or the like, or any combination thereof.

The steering system 295 may be configured to steer the autonomous vehicle 130. In some embodiments, the steering system 295 may steer the autonomous vehicle 130 based on signals transmitted from the SCM 290. For example, the steering system 295 may steer the autonomous vehicle 130 based on the control signals of the control unit 150 transmitted from the SCM 290 in response to a determination that the current driving status is an autonomous driving status. In some embodiments, the steering system 295 may steer the autonomous vehicle 130 based on operations of a human driver. For example, the steering system 295 may turn the autonomous vehicle 130 to a left direction when the human driver turns the steering wheel to a left direction in response to a determination that the current driving status is a manual driving status.

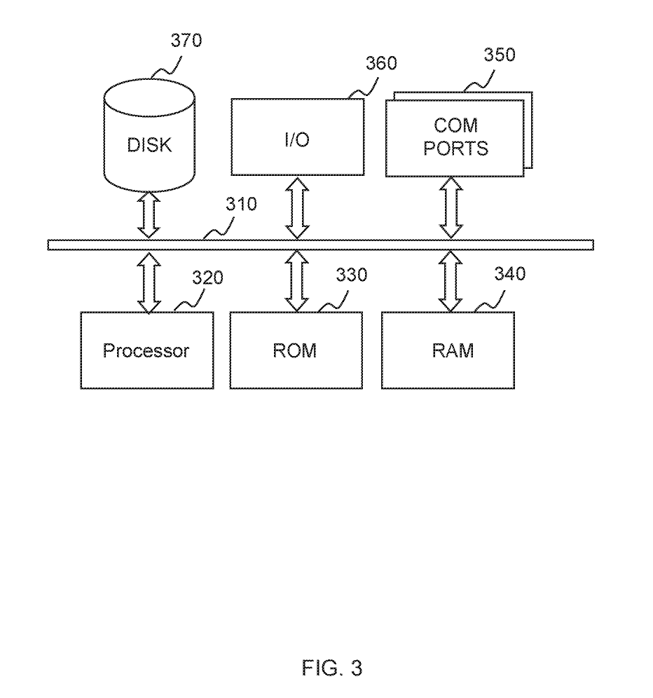

FIG. 3 is a schematic diagram illustrating exemplary hardware and software components of a information processing unit 300 on which the control unit 150, the EMS 260, the ESC 270, the EPS 280, the SCM 290, . . . , may implement according to some embodiments of the present disclosure. For example, the control unit 150 may implement on the information processing unit 300 to perform functions of the control unit 150 disclosed in this disclosure.

The information processing unit 300 may be a a special purpose computer device specially designed to process signals from sensors and/or components of the vehicle 130 and send out instructions to the sensors and/or components of the vehicle 130.

The information processing unit 300, for example, may include COM ports 350 connected to and from a network connected thereto to facilitate data communications. The information processing unit 300 may also include a processor 320, in the form of one or more processors, for executing computer instructions. The computer instructions may include, for example, routines, programs, objects, components, data structures, procedures, modules, and functions, which perform particular functions described herein. For example, the processor 320 may obtain one or more sample features related to a plurality of candidate paths. The one or more sample features related to each of the plurality of candidate paths may include a candidate location (e.g., a coordinate of the candidate location), a candidate velocity, a candidate acceleration, or the like, or any combination thereof.

In some embodiments, the processor 320 may include one or more hardware processors, such as a microcontroller, a microprocessor, a reduced instruction set computer (RISC), an application specific integrated circuits (ASICs), an application-specific instruction-set processor (ASIP), a central processing unit (CPU), a graphics processing unit (GPU), a physics processing unit (PPU), a microcontroller unit, a digital signal processor (DSP), a field programmable gate array (FPGA), an advanced RISC machine (ARM), a programmable logic device (PLD), any circuit or processor capable of executing one or more functions, or the like, or any combinations thereof.

The exemplary information processing unit 300 may include an internal communication bus 310, program storage and data storage of different forms, for example, a disk 370, and a read only memory (ROM) 330, or a random access memory (RAM) 340, for various data files to be processed and/or transmitted by the computer. The exemplary information processing unit 300 may also include program instructions stored in the ROM 330, RAM 340, and/or other type of non-transitory storage medium to be executed by the processor 320. The methods and/or processes of the present disclosure may be implemented as the program instructions. The information processing unit 300 also includes an I/O component 360, supporting input/output between the computer and other components (e.g., user interface elements). The information processing unit 300 may also receive programming and data via network communications.

Merely for illustration, only one processor is described in the information processing unit 300. However, it should be noted that the information processing unit 300 in the present disclosure may also include multiple processors, thus operations and/or method steps that are performed by one processor as described in the present disclosure may also be jointly or separately performed by the multiple processors. For example, if in the present disclosure the processor 320 of the information processing unit 300 executes both step A and step B, it should be understood that step A and step B may also be performed by two different processors jointly or separately in the information processing unit 300 (e.g., the first processor executes step A and the second processor executes step B, or the first and second processors jointly execute steps A and B).

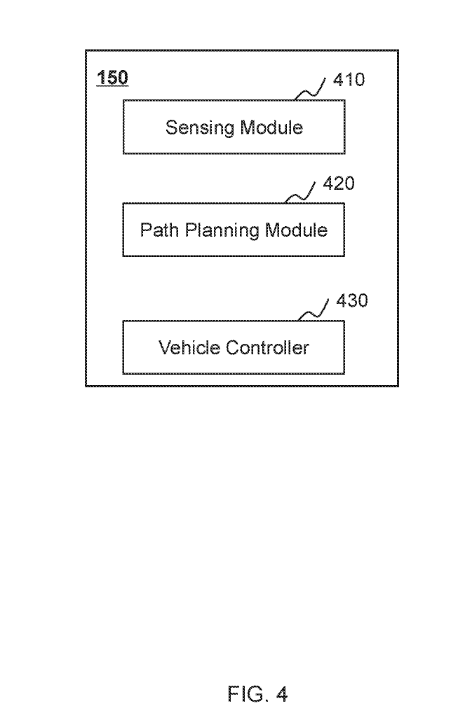

FIG. 4 is a block diagram illustrating an exemplary control unit 150 according to some embodiments of the present disclosure. The control unit 150 may include a sensing module 410, a path planning module 420, and a vehicle controller 430. Each module may be a hardware circuit that is designed to perform the following actions, a set of instructions stored in one or more storage media, and/or a combination of the hardware circuits and the one or more storage media.

The sensing module 410 may be configured to sense and generate driving information around a vehicle (e.g., an autonomous vehicle 130). The sensing module 410 may sense and generate real-time driving information around the autonomous vehicle. In some embodiments, the sensing module 410 may send the real-time driving information around the autonomous vehicle to other modules or storages for further processing. For example, the sensing module 410 may send the real-time driving information around the autonomous vehicle to the path planning module 420 for path planning, collision avoiding, etc. For another example, the sensing system may send the real-time driving information around the autonomous vehicle to a storage medium (e.g., the storage 220).

In some embodiments, the real-time driving information may include obstacle information, vehicle information, road information, weather information, traffic rules, or the like, or any combination thereof. The obstacle information may include an obstacle classification (e.g., a car, a pedestrian, pit in a road, etc.,) an obstacle type (e.g., a static obstacle or a motional obstacle), an obstacle location (e.g., coordinates of a profile of the obstacle), an observed obstacle path (e.g., moving path of the obstacle in a past period of time), a predicted obstacle path (e.g., moving path of the obstacle in a prospective period of time), an obstacle velocity, or the like, or any combination thereof. The vehicle information may include a contour of the autonomous vehicle, a turning circle of the autonomous vehicle, a type of the autonomous vehicle, an insurance of the autonomous vehicle, a safe preference of the autonomous vehicle, or the like, or any combination thereof. The road information may include traffic signs/lights, a road marking, a lane marking, a road edge, a lane, an available lane, a speed limit, a road surface status, a traffic condition, or the like, or any combination thereof.

In some embodiments, the sensing module 410 may receive sensor signals from one or more sensors (e.g., sensor 142, sensor 144, sensor 146), and sense and generate driving information around a vehicle based on the sensor signals. The one or more sensors may include a distance sensor, a velocity sensor, an acceleration sensor, a steering angle sensor, a traction-related sensor, a braking-related sensor, or the like, or any combination thereof. The sensor signals may be electronic wave coding the environment information around the autonomous vehicle.

In some embodiments, the sensing module 410 may receive data from a global positioning system (GPS), an inertial measurement unit (IMU), a map, a data store, the network 230, etc. For example, the sensing module 410 may receive GPS data from a GPS and generate location information with respect to the autonomous vehicle and/or one or more obstacles based on the data. For another example, the sensing module 410 may receive vehicle information from the storage 220 and/or the network 230.

The path planning module 420 may be configured to generate an optimized path for the autonomous vehicle. In some embodiments, the path planning module 420 may generate the optimized path based on the real-time driving information. The path planning module 420 may obtain the real-time driving information from a storage medium (e.g., the storage 220), or obtain the real-time driving information from the sensing module 410. The path planning module 420 may generate and send signals encoding the optimized path to other components of the autonomous vehicle 130 to control operations of the autonomous vehicle (e.g., steering, braking, accelerating, etc.)

The vehicle controller 430 may be configured to generate driving operation signals based on the signals encoding the optimized path. In some embodiments, the vehicle controller 430 may generate driving operation signals based on the signal encoding optimized path generated by the path planning module 420. The vehicle controller 430 may generate the driving operation signal based on the optimized path and send the driving operation signals to other modules (e.g., the Engine Management System 260, the Electric Stability Control 270, the Electric Power System (EPS) 280, the Steering Column Module 290, etc.)

In some embodiments, the driving operation signal may include power supplying signal, braking signal, steering signal, or the like, or any combination thereof. The power supplying signal may include a real-time velocity, a velocity limit, a planned velocity, an acceleration, an acceleration limit, or the like, or any combination thereof. The steering signal may include a turning circle, a real-time velocity, a real-time acceleration, a real-time location, a planned location, an available lane, a weather condition, or the like, or any combination thereof. In some embodiments, the braking signal may include a braking distance, a tire friction, a roughness of a road surface, a weather condition, an angle of a slope (e.g., a downhill slope), a planned velocity, an acceleration limit, or the like, or any combination thereof.

The modules in the control unit 150 may be connected to or communicate with each other via a wired connection or a wireless connection. The wired connection may include a metal cable, an optical cable, a hybrid cable, or the like, or any combination thereof. The wireless connection may include a Local Area Network (LAN), a Wide Area Network (WAN), a Bluetooth, a ZigBee, a Near Field Communication (NFC), or the like, or any combination thereof. Any two of the modules may be combined as a single module, any one of the modules may be divided into two or more units.

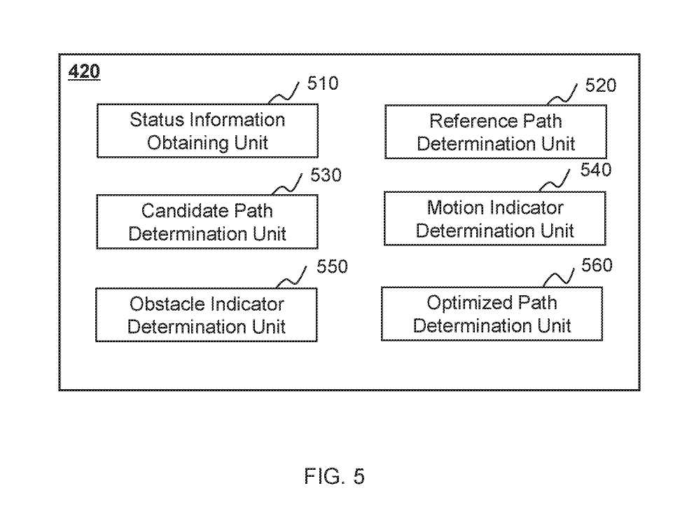

FIG. 5 is a block diagram illustrating a path planning module 420 according to some embodiments of the present disclosure. The path planning module 420 may include a status information obtaining unit 510, a reference path determination unit 520, a candidate path determination unit 530, a motion indicator determination unit 540, an obstacle indicator determination unit 550, and an optimized path determination unit 560. Each module may be a hardware circuit that is designed to perform the following actions, a set of instructions stored in one or more storage media, and/or a combination of the hardware circuits and the one or more storage media.

The status information obtaining unit 510 may be configured to obtain status information of a vehicle (also referred to herein as vehicle status information). In some embodiments, the status information obtaining unit 510 may obtain the vehicle status information from one or more sensors (e.g., sensors 142, 144 and 146). The one or more sensors may include a distance sensor, a velocity sensor, an acceleration sensor, a steering angle sensor, a traction-related sensor, a braking-related sensor, and/or any sensor configured to sense information relating to motional situation of the vehicle. In some embodiments, the status information obtaining unit 510 may send the obtained vehicle status information to other units for further processing (e.g., the reference path determination unit 520, the candidate path determination unit 530). In some embodiments, the status information obtaining unit 510 may obtain the vehicle status information from the Engine Management System 260, the Electric Stability Control 270, the Electric Power System (EPS) 280, or the Steering Column Module 290.

In some embodiments, the vehicle status information may include a driving direction of the vehicle, an instantaneous velocity of the vehicle, an instantaneous acceleration of the vehicle, an environment information around the vehicle, etc. For example, the environment information may include a road edge, a lane, an available lane, a road type, a speed limit, a road surface status, a traffic condition, a weather condition, obstacle information, or the like, or any combination thereof.

The reference path determination unit 520 may be configured to determine a reference path including one or more reference samples. The determined reference samples may be stored in any storage medium (e.g., the storage 220) of the autonomous vehicle 130. In some embodiments, the reference path determination unit 520 may determine the one or more reference samples based on the vehicle status information. The reference path determination unit 520 may obtain the vehicle status information from a storage medium (e.g., the storage 220), or from the sensing module 410, or from the status information obtaining unit 510.

In some embodiments, each of the one or more reference samples may include a plurality of reference sample features. The plurality of reference sample features may include a reference velocity, a reference acceleration, a reference location (e.g., a coordinate), or the like, or a combination thereof.

The candidate path determination unit 530 may be configured to determine a candidate path including one or more candidate samples. The determined candidate samples may be stored in any storage medium (e.g., the storage 220) in the autonomous vehicle 130. In some embodiments, the candidate path determination unit 530 may determine the one or more candidate samples based on the vehicle status information. The candidate path determination unit 530 may obtain the vehicle status information from a storage medium (e.g., the storage 220), or from the status information obtaining module 310, or from the status information obtaining unit 510.

In some embodiments, each of the one or more candidate samples may include a plurality of candidate sample features. The plurality of candidate sample features may include a candidate velocity, a candidate acceleration, a candidate location (e.g., a coordinate), or the like, or a combination thereof.

The motion indicator determination unit 540 may be configured to determine one or more motion indicators based on the reference path and the candidate path. In some embodiments, the motion indicator determination unit 540 may determine the one or more motion indicators by calculating one or more kinematic differences between one or more reference sample features of a reference sample and one or more candidate sample features of a corresponding candidate sample. For example, the motion indicator determination unit 540 may determine kinematic differences between reference velocity of the reference sample and candidate velocity of the candidate sample at the same sample time, and determine an indicator related to velocity by adding all the kinematic differences together.

The obstacle indicator determination unit 550 may be configured to determine an obstacle indicator (or referred to herein as a fourth indicator) based on the candidate path and the status information (e.g., the environment information around the vehicle). The environment information and the candidate sample may be stored in any storage medium (e.g., the storage 220) in the autonomous vehicle 130. The obstacle indicator determination unit 550 may determine the fourth indicator based on one or more obstacles. The one or more obstacles may include static obstacles and motional obstacles. The static obstacles may include a building, tree, roadblock, or the like, or any combination thereof. The motional obstacles may include moving vehicles, pedestrians, and/or animals, or the like, or any combination thereof. In some embodiments, the obstacle indicator determination unit 550 may determine the fourth indicator by evaluating one or more obstacle distances. As used herein, the one or more obstacle distances may refer to one or more distances between the vehicle and the one or more obstacles. For example, the obstacle indicator determination unit 550 may determine the fourth indicator by evaluating the one or more obstacle distances based on a potential field theory.

The optimized path determination unit 560 may be configured to determine an optimized path. In some embodiments, the optimized path determination unit 560 may obtain a plurality of indicators (e.g., indicators determined by the motion indicator determination unit 540 and the obstacle indicator determination module 450) from a storage medium (e.g., the storage 220). The optimized path determination unit 560 may determine a plurality of weights for each of the plurality of indicators. The optimized path determination unit 560 may determine a loss function based on the plurality of indicators and the plurality of weights thereof. As used herein, the loss function may refer to kinematic differences between the reference path and the candidate path, energy differences (e.g., differences of potential energy) between the candidate path and the reference path, and/or a combination of the kinematic differences and the energy differences. The kinematic differences may be determined through comparing velocities, accelerations, and/or locations (e.g., coordinates) of the autonomous vehicle on the candidate path and the reference path. For example, the kinematic differences may be a shape difference between the driving path and the candidate path (differences between locations of the points on the candidate path and the reference path. The energy may be of a form of potential energy in a predefined energy field. For example, the predefined energy field may be an imaginary energy field inversely proportional to the distances between the autonomous vehicle and the one or more obstacles. In some embodiments, the optimized path determination unit 560 may determine a minimum value for the loss function. For example, the optimized path determination unit 560 may determine the minimum value based on a gradient descent method. The optimized path determination unit 560 may update the candidate samples of the candidate path to generate an optimized candidate path until the updated candidate sample of the optimized candidate path produces a minimum value for the loss function.

The units in the control unit 150 may be connected to or communicate with each other via a wired connection or a wireless connection. The wired connection may include a metal cable, an optical cable, a hybrid cable, or the like, or any combination thereof. The wireless connection may include a Local Area Network (LAN), a Wide Area Network (WAN), a Bluetooth, a ZigBee, a Near Field Communication (NFC), or the like, or any combination thereof. Any two of the units may be combined as a single unit, any one of the units may be divided into two or more sub-units.

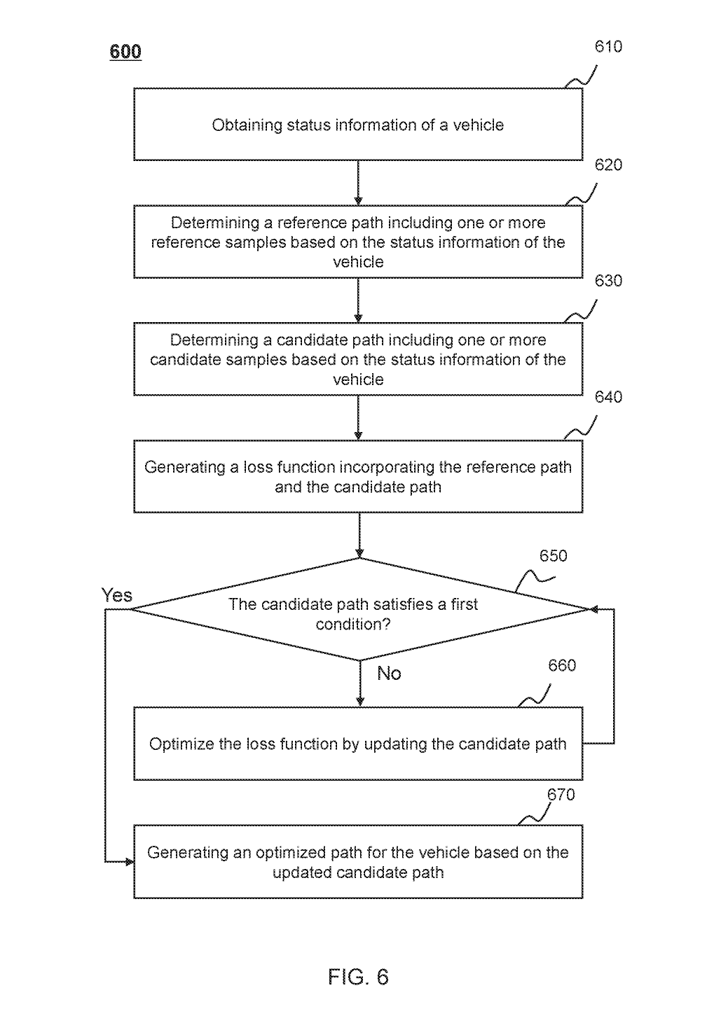

FIG. 6 is flowchart illustrating an exemplary process and/or method for determining an optimized path according to some embodiments of the present disclosure. The process and/or method 600 may be executed by a processor in the autonomous vehicle 130 (e.g., the control unit 150). For example, the process and/or method 600 may be implemented as a set of instructions (e.g., an application) stored in a non-transitory computer readable storage medium (e.g., the storage 220). The processor may execute the set of instructions and may accordingly be directed to perform the process and/or method 600 via receiving and/or sending electronic signals.

In step 610, the control unit 150 (e.g., the status information obtaining unit 510) may obtain status information of a vehicle (also referred to as “vehicle status information” in the present disclosure).

The autonomous vehicle may include one or more sensors (e.g., a radar, a lidar) to sense information about the vehicle status information and/or the environment around the vehicle. In some embodiments, the vehicle status information may include a driving direction of the vehicle, a velocity (e.g., an instantaneous velocity, an average velocity) of the vehicle, an acceleration (e.g., an instantaneous acceleration, an average acceleration) of the vehicle, environment information around the vehicle, a current time, or the like, or any combination thereof.

In step 620, the control unit 150 (e.g., the reference path determination unit 520) may determine a reference path including one or more reference samples based on the vehicle status information.

A reference path may be a path that an autonomous vehicle would go along without considering an obstacle. For example, as shown in FIG. 1, without considering the obstacle, a reference path of the autonomous vehicle 130 may be a center line of the lane 122. A reference sample may include one or more reference sample features. The one or more reference sample features may include a reference location information (e.g., a coordinate), a sample time related to the reference location, a reference velocity related to the reference location, a reference acceleration related to the reference location. The reference location may be a location on the reference path. The sample time related to the reference location may be a time when the autonomous vehicle would go across the reference location. In some embodiments, time interval of adjacent sample times of different reference samples may be the same. The reference velocity related to the reference location may be a velocity of the autonomous vehicle 130 when the autonomous vehicle is crossing the reference location. The reference acceleration related to the reference location may be an acceleration of the autonomous vehicle 130 when the autonomous vehicle is crossing the reference location. Merely by way of example, the reference path may include N reference samples associated with an M seconds' period. The N reference samples may be expressed as {reference sample 1, reference sample 2, . . . , reference sample i, . . . , and reference sample N}. Reference sample 1 may correspond to a sample time at M/N second, reference sample 2 may correspond to a sample time at 2*M/N second, reference sample i may correspond to a sample time at i*M/N second, etc. i or N or M may represent an integer larger than 1, and M/N may be a rational number. Merely by way of example, M may be 5 when N may be 50.

In some embodiments, the control unit 150 (e.g., the reference path determination unit 520) may determine the reference sample features of the reference samples based on the environment information around the vehicle. For example, the control unit 150 (e.g., the reference path determination unit 520) may determine one or more reference locations from a starting location (e.g., the reference location of reference sample 1) along the driving direction based on an available lane. For another example, the control unit 150 (e.g., the reference path determination unit 520) may determine one or more reference velocities based on the speed limit of a road. As still another example, when moving on a curved road, the control unit 150 (e.g., the reference path determination unit 520) may determine a slower reference velocity relative to that on a straight road. In some embodiments, the control unit 150 (e.g., the reference path determination unit 520) may determine the one or more reference samples based on a user input. In some embodiments, the control unit 150 (e.g., the reference path determination unit 520) may determine one or more reference sample features of the one or more reference samples based on a default setting. For example, the reference path determination unit 520 may determine one or more reference accelerations based on the default settings of the autonomous vehicle 130. The default settings of the autonomous vehicle 130 may prefer a constant acceleration to make the passenger comfortable. In some embodiments, the control unit 150 (e.g., the reference path determination unit 520) may determine one or more reference sample features of the one or more reference samples based on a machine learning technique. The machine learning technique may include an artificial neural network, support vector machine (SVM), decision tree, random forest, or the like, or any combination thereof. For example, the control unit 150 (e.g., the reference path determination unit 520) may determine one or more reference accelerations based on a machine learning technique.

In step 630, the control unit 150 (e.g., the candidate path determination unit 530) may determine a candidate path including one or more candidate samples based on the status information of the vehicle.

A candidate path may be a path that an autonomous vehicle would go along with considering an obstacle. For example, with considering the obstacle, a candidate path of the autonomous vehicle 130 may be not the center line of the lane 122, since there is an obstacle 110 in the center line of the lane 122. A candidate sample may include one or more candidate sample features. The one or more candidate sample features may include a candidate location information (e.g., a coordinate), a sample time related to the candidate location, a candidate velocity related to the candidate location, a candidate acceleration related to the candidate location. The candidate location may be a location on the candidate path. The sample time related to the candidate location may be a time when the autonomous vehicle would go across the candidate location. In some embodiments, time interval of adjacent sample times of different candidate samples may be the same. The candidate velocity related to the candidate location may be a velocity of the autonomous vehicle 130 when the autonomous vehicle is crossing the candidate location. The candidate acceleration related to the candidate location may be an acceleration of the autonomous vehicle 130 when the autonomous vehicle is crossing the candidate location. Merely by way of example, the candidate path may include N candidate samples associated with an M seconds' period. The N candidate samples may be expressed as {candidate sample 1, candidate sample 2, . . . , candidate sample i, . . . , and candidate sample N}. Candidate sample 1 may correspond to a sample time at M/N second, candidate sample 2 may correspond to a sample time at 2*M/N second, candidate sample i may correspond to a sample time at i*M/N second, etc. i or N or M may represent an integer larger than 1, and M/N may be a rational number. Merely by way of example, M may be 5 when N may be 50.

In some embodiments, the control unit 150 (e.g., the candidate path determination unit 530) may determine one or more candidate sample features of the one or more candidate samples based on the environment information around the vehicle. For example, the control unit 150 (e.g., the candidate path determination unit 530) may determine one or more candidate locations from a starting location (e.g., the candidate location of candidate sample 1) along the driving direction based on an available lane.

In some embodiments, the candidate velocity at the candidate location may be determined based on a differential with respect to adjacent candidate locations and sample time of the candidate sample. Merely by way of example, the N candidate samples may be expressed as {candidate sample 1, candidate sample 2, . . . , candidate sample i, . . . , and candidate sample N}. If the candidate velocity of the candidate sample 1 is determined, the candidate velocity related to the candidate sample 2 may be determined based on a kinematic difference of the candidate location of candidate sample 1 and the candidate location of candidate sample 2 and a time interval between the sample time related to the candidate sample 1 and the sample time related to the candidate sample 2.

In step 640, the control unit 150 (e.g., the optimized path determination unit 560) may generate a loss function incorporating the reference path and the candidate path.

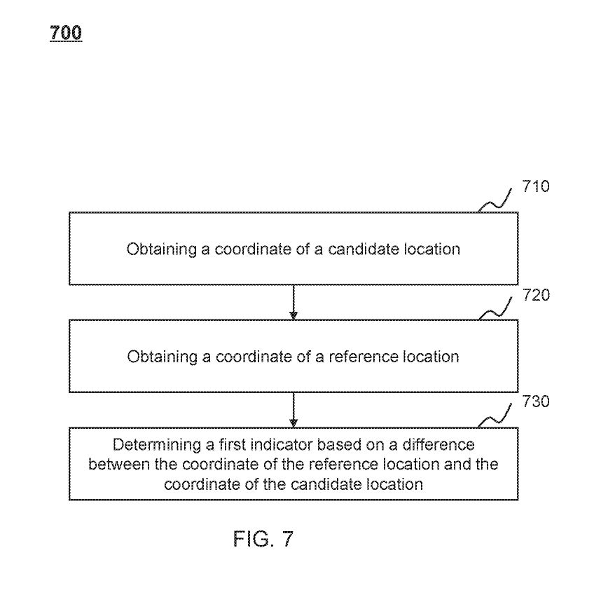

Based on the one or more reference samples and the one or more candidate samples, a plurality of indicators may be determined. The plurality of indicators may be determined based on kinematic differences and an energy difference between sample features of a candidate sample and sample features of a reference sample having the same sample time as the candidate sample. In some embodiments, the plurality of indicators may be determined by performing one or more operations described in connection with FIGS. 7-9 and FIG. 11. The loss function may include a plurality of weights corresponding to the plurality of indicators. The plurality of weights corresponding to the plurality of indicators may be determined based on the status information of the vehicle (e.g., weather condition, road surface status, traffic condition, obstacle information, etc.) The control unit 150 (e.g., the optimized path determination unit 560) may further determine the loss function based on the plurality of weights corresponding to the plurality of indicators.

In step 650, the control unit 150 (e.g., the optimized path determination unit 560) may determine whether the candidate path satisfies a first condition. The first condition may be that the one or more candidate samples of the candidate path produce a minimum value for the loss function. The minimum value for the loss function may indicate that the candidate driving path on which an autonomous vehicle is driving may be an optimized path in terms of the velocity, the path and the acceleration provided by the reference path, and at the same time, avoids collisions with the one or more obstacles. In response to the determination that the candidate path does not satisfy the first condition, the control unit 150 (e.g., the optimized path determination unit 560) may optimize the loss function by updating the candidate sample in step 660.

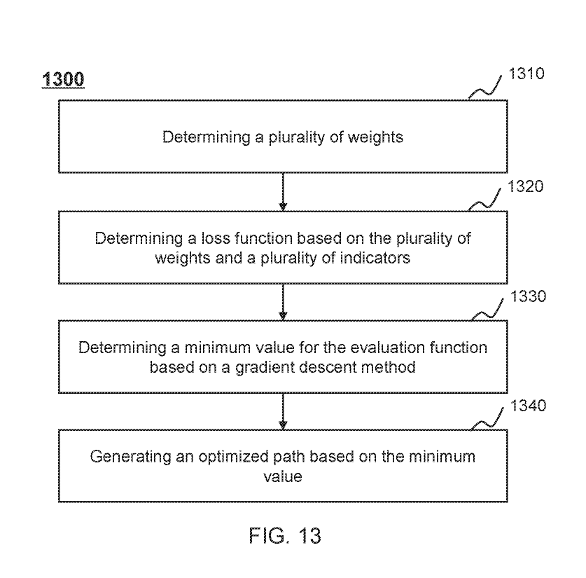

In step 660, the control unit 150 (e.g., the optimized path determination unit 560) may optimize the loss function by updating the one or more candidate samples of the candidate path based on the loss function. For example, the optimized path determination unit 560 may further update the one or more candidate samples based on the loss function using a gradient descent method. In some embodiments, the one or more candidate samples may be updated by performing one or more operations described in connection with FIG. 13. The control unit 150 may execute the process 600 to return to step 650 to determine that whether the loss function based on the one or more reference samples and the one or more newly updated candidate samples satisfies the first condition.

On the other hand, in response to the determination that the candidate path satisfies the first condition, the control unit 150 (e.g., the optimized path determination unit 560) may execute the process 600 to jump to step 670 to generate an optimized candidate path.

In step 670, the control unit 150 (e.g., the optimized path determination unit 560) may generate an optimize candidate path. The control unit 150 may send signals encoding the optimized candidate path to the plurality of ECUs (e.g., the EMS 260, the EPS 280, the ESC 270, the SCM 290), thus the autonomous vehicle may drive along the optimized candidate path.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. In some embodiments, the control unit 150 (e.g., the reference path determination unit 520) may determine one or more reference sample features of the one or more reference samples based on live traffic information, such as congestion condition in the city area. In some embodiments, the control unit 150 (e.g., the reference path determination unit 520) may determine one or more reference sample features of the one or more reference samples based on weather information that contributes to the congestion condition in the city. For example, the control unit 150 (e.g., the reference path determination unit 520) may determine a slower reference velocity in a rainy day relative to that in a sunny day. In some embodiments, the control unit 150 (e.g., the reference path determination unit 520) may determine that accelerations at each of the reference locations of the reference path may not exceed a first acceleration threshold to make a passenger in the vehicle comfortable. In some embodiments, one or more other optional steps (e.g., a storing step) may be added elsewhere in the exemplary process 600. In the storing step, the control unit 150 may store the plurality of indicators, the plurality of weights, the candidate samples in any storage device (e.g., the storage 220) disclosed elsewhere in the present disclosure.

FIG. 7 is a flowchart illustrating an exemplary process and/or method for determining a first indicator according to some embodiments of the present disclosure. The process and/or method 700 may be executed by a processor in the autonomous vehicle 130 (e.g., the control unit 150). For example, the process and/or method 700 may be implemented as a set of instructions (e.g., an application) stored in a non-transitory computer readable storage medium (e.g., the storage 220). The processor may execute the set of instructions and may accordingly be directed to perform the process and/or method 700 via receiving and/or sending electronic signals.

In step 710, the control unit 150 (e.g., the motion indicator determination unit 540) may obtain a coordinate of a candidate location. The coordinate of the candidate location may be stored in any storage medium (e.g., the storage 220) of the autonomous vehicle 130. In some embodiments, the motion indicator determination unit 540 may obtain the coordinate of the candidate location from the candidate path.

In step 720, the control unit 150 (e.g., the motion indicator determination unit 540) may obtain a coordinate of a reference location. The sample time related to the candidate sample obtained in step 710 may be the same as the sample time related to the reference sample obtained in step 720. The coordinate of the reference location may be stored in any storage medium (e.g., the storage 220) of the autonomous vehicle 130. In some embodiments, the motion indicator determination unit 540 may obtain the coordinate of the reference location from the reference path.

In step 730, control unit 150 (e.g., the motion indicator determination unit 540) may determine a first indicator based on a kinematic difference between the coordinate of the candidate location obtained in step 710 and the coordinate of the reference location obtained in step 720. The first indicator may be configured to evaluate a distance deviation between the reference path and the candidate path. In some embodiments, the candidate path may be configured to avoid collisions with one or more obstacles. Merely by way of example, the first indicator for a sample feature related to a reference path with N reference samples and a candidate path with N candidate samples may be determined by the formula below:

C_offset=½Σᵢ₌₁^{i=N}(p_{candidate sample i}−p_{reference sample i})², (1)

where C_offset may represent the first indicator, P_{reference sample i} may denote the reference location of a reference sample i, p_{candidate sample i} may denote the candidate location of a candidate sample i.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, one or more other optional steps (e.g., a storing step) may be added elsewhere in the exemplary process 700. In the storing step, the control unit 150 may store the kinematic difference between the coordinate of the reference location and the coordinate of the candidate location, and/or the first indicator in any storage device (e.g., the storage 220) disclosed elsewhere in the present disclosure.

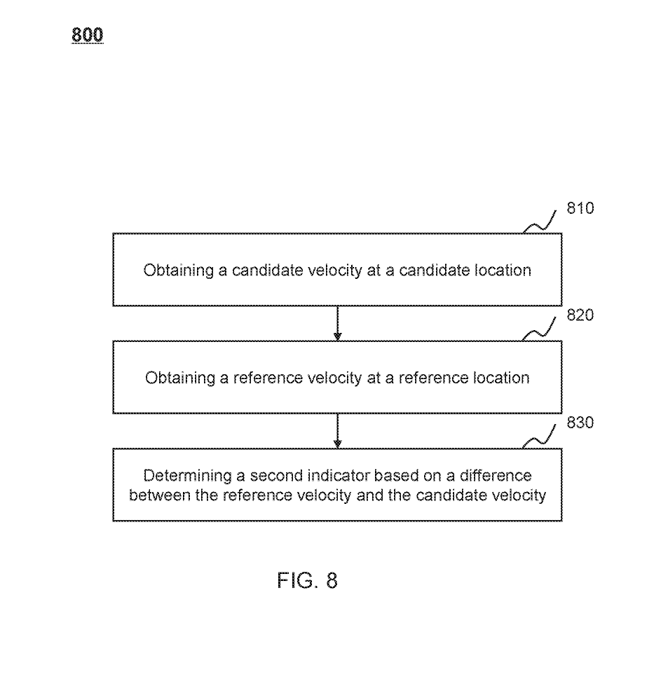

FIG. 8 is a flowchart illustrating an exemplary process and/or method for determining a second indicator according to some embodiments of the present disclosure. The process and/or method 800 may be executed by a processor in the autonomous vehicle 130 (e.g., the control unit 150). For example, the process and/or method 800 may be implemented as a set of instructions (e.g., an application) stored in a non-transitory computer readable storage medium (e.g., the storage 220). The processor may execute the set of instructions and may accordingly be directed to perform the process and/or method 800 via receiving and/or sending electronic signals.

In step 810, the control unit 150 (e.g., the motion indicator determination unit 540) may obtain a candidate velocity at a candidate location. The candidate velocity at the candidate location may be stored in any storage medium (e.g., the storage 220) of the autonomous vehicle 130.

In some embodiments, the candidate velocity at the candidate location may be determined based on a differential with respect to adjacent candidate locations and sample time of the candidate sample. Merely by way of example, the N candidate samples may be expressed as {candidate sample 1, candidate sample 2, . . . , candidate sample i, . . . , and candidate sample N}. If the candidate velocity of the candidate sample 1 is determined, the candidate velocity related to the candidate sample 2 may be determined based on a kinematic difference of the candidate location of candidate sample 1 and the candidate location of candidate sample 2 and a time interval between the sample time related to the candidate sample 1 and the sample time related to the candidate sample 2.

In step 820, the control unit 150 (e.g., the motion indicator determination unit 540) may obtain a reference velocity at a reference location. The sample time related to the candidate sample obtained in step 810 may be the same as the sample time related to the reference sample obtained in step 820.

In some embodiments, the reference velocity at the reference location may be determined based on a differential with respect to adjacent reference locations and sample time related to the reference sample. Merely by way of example, the N reference samples may be expressed as {reference sample 1, reference sample 2, . . . , reference sample i, . . . , and reference sample N}. If the reference velocity of the reference sample 1 is determined, the reference velocity of the reference sample 2 may be determined based on a kinematic difference of the reference location of reference sample 1 and the reference location of reference sample 2 and a time interval between the sample time related to the reference sample 1 and the sample time related to the reference sample 2.

In step 830, control unit 150 (e.g., the motion indicator determination unit 540) may determine a second indicator based on a kinematic difference between the reference velocity at the reference location and the candidate velocity at the candidate location. The second indicator may be configured to evaluate a deviation between velocities of the autonomous vehicle determined by the candidate path and velocities of the autonomous vehicle determined by the reference path. Merely by way of example, the second indicator for a sample feature related to a reference path with N reference samples and a candidate path with N candidate samples may be determined by the formula below:

C_vcl=½Σᵢ₌₁^{i=N}(v_{candidate sample i}−v_{reference sample i})², (2)

where C_vcl may represent the second indicator, v_{reference sample i} may denote the reference velocity of a reference sample i, v_{candidate sample i} may denote the candidate velocity of a candidate sample i.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, one or more other optional steps (e.g., a storing step) may be added elsewhere in the exemplary process 800. In the storing step, the control unit 150 may store the kinematic difference between the reference velocity at the reference location and the candidate velocity at the candidate location, and/or the second indicator in any storage device (e.g., the storage 220) disclosed elsewhere in the present disclosure.

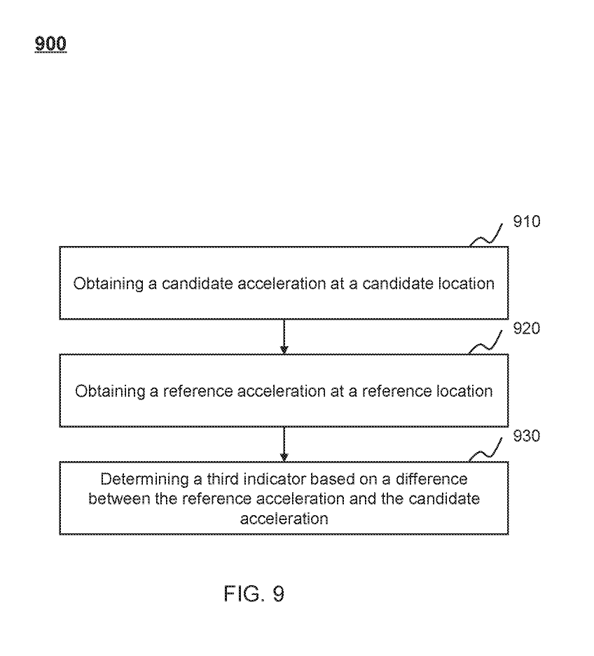

FIG. 9 is a flowchart illustrating an exemplary process and/or method for determining a third indicator according to some embodiments of the present disclosure. The process and/or method 900 may be executed by a processor in the autonomous vehicle 130 (e.g., the control unit 150). For example, the process and/or method 900 may be implemented as a set of instructions (e.g., an application) stored in a non-transitory computer readable storage medium (e.g., the storage 220). The processor may execute the set of instructions and may accordingly be directed to perform the process and/or method 900 via receiving and/or sending electronic signals.

In step 910, the control unit 150 (e.g., the motion indicator determination unit 540) may obtain a candidate acceleration at a candidate location. The candidate acceleration at the candidate location may be stored in any storage medium (e.g., the storage 220) of the autonomous vehicle 130.

In some embodiments, the candidate acceleration at the candidate location may be determined based on a differential with respect to adjacent candidate velocities and sample time of the candidate sample. Merely by way of example, the N candidate samples may be expressed as {candidate sample 1, candidate sample 2, . . . , candidate sample i, . . . , and candidate sample N}. If the candidate acceleration of the candidate sample 1 is determined, the candidate acceleration related to the candidate sample 2 may be determined based on a kinematic difference of the candidate velocity of candidate sample 1 and the candidate velocity of candidate sample 2 and a time interval between the sample time related to the candidate sample 1 and the sample time related to the candidate sample 2.

In step 920, the control unit 150 (e.g., the motion indicator determination unit 540) may obtain a reference acceleration at a reference location. The sample time related to the candidate sample obtained in step 910 may be the same as the sample time related to the reference sample obtained in step 920.

In step 930, the control unit 150 (e.g., the motion indicator determination unit 540) may determine a third indicator based on a kinematic difference between the reference acceleration at the reference location and the candidate acceleration at the candidate location. The second indicator may be configured to evaluate a deviation between accelerations of the autonomous vehicle determined by the candidate path and accelerations of the autonomous vehicle determined by the reference path. Merely by way of example, the third indicator related to a reference path with N reference samples and a candidate path with N candidate samples may be determined by the formula below:

C_acc=½Σᵢ₌₁^{i=N}(a_{candidate sample i}−a_{reference sample i})², (3)

where C_acc may represent the third indicator, a_{reference sample i} may denote the reference acceleration of a reference sample i, a_{candidate sample i} may denote the candidate acceleration of a candidate sample i.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, one or more other optional steps (e.g., a storing step) may be added elsewhere in the exemplary process 900. In the storing step, the control unit 150 may store the kinematic difference between the reference acceleration at the reference location and the candidate acceleration at the candidate location, and/or the third indicator in any storage device (e.g., the storage 220) disclosed elsewhere in the present disclosure.

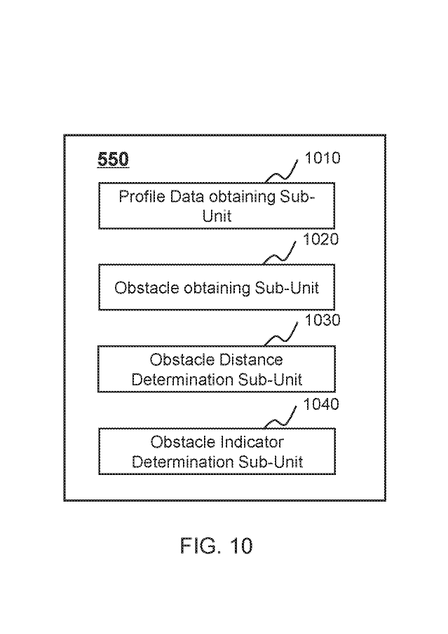

FIG. 10 is a block diagram illustrating an exemplary obstacle indicator determination unit 550 according to some embodiments of the present disclosure. The obstacle indicator determination unit 550 may include a profile data obtaining sub-unit 1010, an obstacle obtaining sub-unit 1020, an obstacle distance determination sub-unit 1030, and an obstacle indicator determination sub-unit 1040.

The profile data obtaining sub-unit 1010 may obtain profile data of a vehicle. In some embodiments, the profile data obtaining sub-unit 1010 may obtain the profile data of the vehicle from a storage medium (e.g., the storage 220) in the autonomous vehicle 130. As used herein, the profile data of the vehicle may refer to a three dimensional profile of the vehicle. In some embodiments, the profile data of the vehicle may be generated based on a scanner system. For example, the scanner system may generate a complete set of data points representing the profile of the vehicle. In some embodiments, the profile data of the vehicle may be represented by a plurality of coordinates. The plurality of coordinates may be determined based on the outermost edge of the vehicle and the location of the vehicle.

The obstacle obtaining sub-unit 1020 may obtain obstacle information around the vehicle. In some embodiments, the obstacle obtaining sub-unit 1020 may obtain the obstacle information around the vehicle from a storage medium (e.g., the storage 220) in the autonomous vehicle 130. In some embodiments, the obstacle obtaining sub-unit 1020 may obtain obstacle information around the vehicle from one or more sensors. In some embodiments, the one or more sensors may be configured to obtain a plurality of images and/or data of the environment information around the vehicle, and may include one or more video cameras, laser-sensing devices, infrared-sensing devices, acoustic-sensing devices, thermal-sensing devices, or the like, or any combination thereof.

The obstacle information around the vehicle may be associated with one or more obstacles (e.g., static obstacles, motional obstacles). In some embodiments, the one or more obstacles may be within a predetermined area around the vehicle. The static obstacles may include a building, tree, roadblock, or the like, or any combination thereof. The motional obstacles may include vehicles, pedestrians, and/or animals, or the like, or any combination thereof.

The obstacle information may include locations of the one or more obstacles, sizes of the one or more obstacles, types of the one or more obstacles, motion status of the one or more obstacles, moving velocities of the one or more obstacles, or the like, or any combination thereof.

The obstacle distance determination sub-unit 1030 may determine one or more obstacle distances. In some embodiments, the obstacle distance determination sub-unit 1030 may determine the one or more obstacle distances based on the obstacle information and a candidate path determined by one or more candidate path samples. For example, the obstacle distance determination sub-unit 1030 may determine the one or more obstacle distances based on the obstacle information and candidate locations of the candidate samples. The candidate locations of the candidate samples may be associated with a plurality of time nodes.

In some embodiments, for a static obstacle, the obstacle distance determination sub-unit 1030 may determine a distance between the static obstacle and a candidate location of the candidate sample. For example, the distance between the static obstacle and the candidate location may be determined based on the coordinate of the location of the static obstacle and the coordinate of the candidate location. In some embodiments, for a motional obstacle, the obstacle distance determination sub-unit 1030 may determine a distance between the motional obstacle and a candidate location of the candidate path by regarding the motional obstacle as a static obstacle at the sample time associated with the candidate location. For example, the obstacle distance determination sub-unit 1030 may predict the location of the motional obstacle at a specific sample time based on information of the motional obstacle (e.g., current location of the motional obstacle, velocity of the motional obstacle, moving direction of the motional obstacle, etc) and determine the obstacle distance based on the coordinate of the predicted location and the coordinate of a candidate location associated with the specific time node.

For illustration purposes, the present disclosure takes a single static obstacle and a single motional obstacle as an example, it should be noted that the control unit 150 may determine the one or more obstacle distances based on all obstacles with the predetermined area.

The obstacle indicator determination sub-unit 1040 may be configured to determine an obstacle indicator (or referred to herein as a fourth indicator). In some embodiments, the obstacle indicator determination unit 1040 may be configured to determine the fourth indicator based on the one or more obstacle distances. In some embodiments, the obstacle indicator determination unit 1040 may determine the fourth indicator by evaluating the one or more obstacle distances based on a potential field theory. The obstacle indicator determination unit 1040 may evaluate the one or more obstacle distances based on a potential function. The value of the potential function may decrease when the one or more obstacle distances increase. In some embodiments, the obstacle indicator determination unit 1040 may further determine the fourth indicator based on the profile data of the vehicle.

It should be noted that the above description is provided for the purpose of illustration, and not intended to limit the scope of the present disclosure. For persons having ordinary skills in the art, two or more of the units may be combined into a single module, and any one of the units may be divided into two or more sub-units. Various variations and modifications may be conducted under the teaching of the present disclosure. However, those variations and modifications may not depart from the spirit and scope of this disclosure. For example, the obstacle obtaining sub-unit 1020 and the obstacle distance determination sub-unit 1030 may be combined as a single module which may both obtain the obstacle information and determine the one or more obstacle distances based on the obstacle information. As another example, the obstacle distance determination sub-unit 1030 may include a storage unit (not shown) which may be used to store any information (e.g., the obstacle information, the one or more obstacle distances) associated with the fourth indicator.

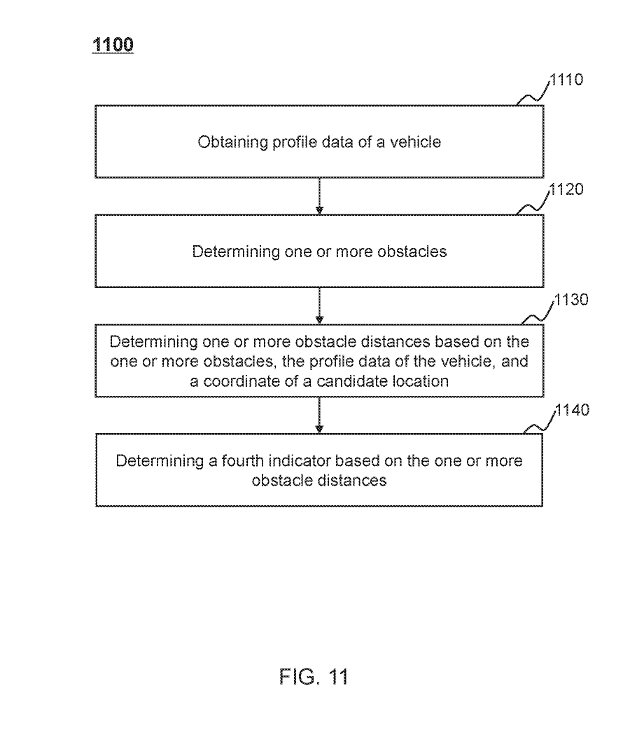

FIG. 11 is a flowchart illustrating an exemplary process and/or method for determining a fourth indicator according to some embodiments of the present disclosure. The process and/or method 1100 may be executed by a processor in the autonomous vehicle 130 (e.g., the control unit 150). For example, the process and/or method 1100 may be implemented as a set of instructions (e.g., an application) stored in a non-transitory computer readable storage medium (e.g., the storage 220). The processor may execute the set of instructions and may accordingly be directed to perform the process and/or method 1100 via receiving and/or sending electronic signals.

In step 1110, the control unit 150 (e.g., the profile data obtaining unit 1010) may obtain profile data of a vehicle. The profile data of the vehicle may include contour data of the vehicle. The contour data may include one or more coordinates of points on the contour of the vehicle. In some embodiments, the profile data may include a coordinate of a geometrical center of the vehicle.

In step 1120, the control unit 150 (e.g., the obstacle obtaining sub-unit 1020) may identify one or more obstacles. In some embodiments, the control unit 150 (e.g., the obstacle obtaining sub-unit 1020) may identify the one or more obstacles based on status information of the vehicle. For example, the control unit 150 (e.g., the obstacle obtaining sub-unit 1020) may determine the one or more obstacles based on obstacle information around the vehicle (e.g., static obstacles, motional obstacles). In some embodiments, the control unit 150 (e.g., the obstacle obtaining sub-unit 1020) may obtain obstacle information around the vehicle from one or more sensors. In some embodiments, the one or more sensors may be configured to obtain a plurality of images and/or data of the environment information around the vehicle, and include one or more video cameras, laser-sensing devices, infrared-sensing devices, acoustic-sensing devices, thermal-sensing devices, or the like, or any combination thereof.

In some embodiments, the one or more obstacles may be within a predetermined area around the vehicle. For example, the one or more obstacles may be distributed along the reference path. In some embodiments, the one or more obstacles may include static obstacles and/or motional obstacles. The static obstacles may include a building, tree, roadblock, or the like, or any combination thereof. The motional obstacles may include vehicles, pedestrians, and/or animals, or the like, or any combination thereof.

The obstacle information may include locations of the one or more obstacles, sizes of the one or more obstacles, types of the one or more obstacles, motion status of the one or more obstacles, moving velocities of the one or more obstacles, or the like, or any combination thereof.

In step 1130, the control unit 150 (e.g., the obstacle distance determination sub-unit 1030) may determine one or more obstacle distances based on the one or more obstacles, the profile data of the vehicle, and a candidate path. In some embodiments, the control unit 150 (e.g., the obstacle distance determination sub-unit 1030) may determine one or more obstacle distances based on the one or more obstacles, the profile data of the vehicle, and a coordinate of a candidate location.

In some embodiments, for a static obstacle, the control unit 150 (e.g., the obstacle distance determination sub-unit 1030) may determine a distance between the static obstacle and the candidate location of the candidate path. For example, the distance between the static obstacle and the candidate location may be determined based on the coordinate of the location of the static obstacle and the coordinate of the candidate location. In some embodiments, for a motional obstacle, the control unit 150 (e.g., the obstacle distance determination sub-unit 1030) may determine a distance between the motional obstacle and the candidate location of a candidate sample by regarding the motional obstacle as a static obstacle at the sample time related to the candidate sample. For example, the control unit 150 may predict the location of the motional obstacle at a specific sample time based on information of the motional obstacle (e.g., current location of the motional obstacle, velocity of the motional obstacle, moving direction of the motional obstacle, etc.) and determine the obstacle distance based on the coordinate of the predicted location and the coordinate of a candidate location associated with the sample time of the candidate sample.

In step 1140, the control unit 150 (e.g., the obstacle indicator determination unit 1040) may determine the fourth indicator (also referred to herein as an obstacle indicator) based on the one or more obstacle distances. The fourth indicator may be configured to evaluate distance between the vehicle and the one or more obstacles in order to avoid collisions with the one or more obstacles.

In some embodiments, the control unit 150 (e.g., the obstacle indicator determination unit 1040) may determine the fourth indicator by evaluating the one or more obstacle distances based on a potential field. The potential field may be a generalized potential field, a harmonic potential field, an artificial potential field, etc. The control unit 150 (e.g., the obstacle indicator determination unit 1040) may evaluate the one or more obstacle distances based on a potential function. The value of the potential function may represent repulsions between the one or more obstacles and the vehicle at each candidate location of the candidate path. The repulsion between one obstacle and the vehicle may decrease when the obstacle distance increases. In some embodiments, the control unit 150 (e.g., the obstacle indicator determination unit 1040) may further determine the fourth indicator based on the profile data of the vehicle.

Merely by way of example, a potential function for a specific candidate location may be determined by the formula below:

$$F ( d ) = {\sum }_{k = 1}^{M} \frac{1}{{d}_{k} + E} , \qquad ( 4 )$$

where F(d) may denote the potential function, dₖ may denote the distance between an obstacle k (e.g., a static obstacle, a motional obstacle) and the specific candidate location, E may denote the profile of the vehicle, M may denote the number of the one or more obstacles.

In some embodiments, the distance between an obstacle and a specific candidate location may further include a safety distance. The safety distance may be determined based on a weather condition, a road surface status, a traffic condition, or the like, or a combination thereof.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, one or more other optional steps (e.g., a storing step) may be added elsewhere in the exemplary process 1100. In the storing step, the control unit 150 may store the one or more obstacle distances and/or the fourth indicator in any storage device (e.g., the storage 220) disclosed elsewhere in the present disclosure.

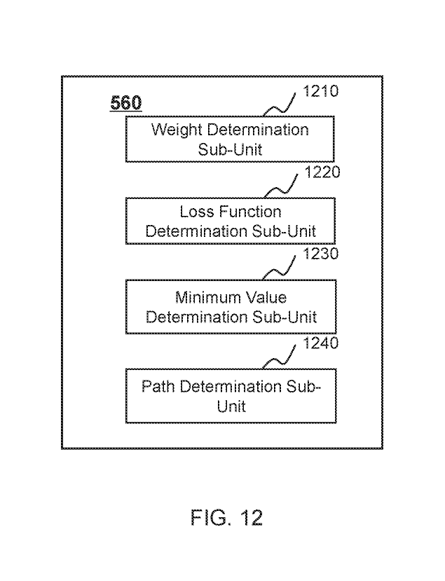

FIG. 12 is a block diagram illustrating an exemplary optimized path determination unit 560 according to some embodiments of the present disclosure. The optimized path determination unit 560 may include a weight determination sub-unit 1210, a loss function determination sub-unit 1220, a minimum value determination sub-unit 1230, and a path determination sub-unit 1240.

The weight determination sub-unit 1210 may determine a plurality of weights for each of a plurality of indicators. In some embodiments, the plurality of indicators may be configured to evaluate sample features of one or more candidate samples. For example, the plurality of indicators may include a first indicator associated with locations, a second indicator associated with velocities, a third indicator associated with accelerations, and a fourth indicator associated with obstacles.

In some embodiments, the weight determination sub-unit 1210 may determine the plurality of weights based on environment information around the vehicle. In some embodiments, the weight determination sub-unit 1210 may determine the plurality of weights based on a user input. In some embodiments, the weight determination sub-unit 1210 may determine the plurality of weights based on a default setting. In some embodiments, the weight determination unit sub-1210 may determine the plurality of weights based on a machine learning technique. The machine learning technique may include an artificial neural network, support vector machine (SVM), decision tree, random forest, or the like, or any combination thereof.

The loss function determination unit sub-1220 may determine a loss function based on the plurality of weights and the plurality of indicators. In some embodiments, the loss function may be configured to evaluate a candidate path determined by the candidate samples based on a reference path. For example, the loss function may evaluate the candidate path determined by the candidate samples based on kinematic differences and energy differences between sample features of the candidate samples and corresponding sample features of the reference samples. The sample features may include a velocity, an acceleration, a location (e.g., a coordinate), or the like, or a combination thereof.

The minimum value determination sub-unit 1230 may determine a minimum value for the loss function based on a gradient descent method. The gradient descent method may be a fast gradient method, a momentum method, etc. In some embodiments, the minimum value determination sub-unit 1230 may determine information related to the gradient descent method. In some embodiments, the minimum value determination sub-unit 1230 may approach the minimum value of the loss function by updating the sample features of the candidate samples. In some embodiments, the minimum value determination sub-unit 1230 may determine a convergence condition. The convergence condition may be configured to determine whether the updated sample features of the candidate samples produce the minimum value for the loss function. The convergence condition may be determined based on a user input, or a default setting.

The path determination sub-unit 1240 may determine an optimized candidate path based on the minimum value. In some embodiments, the path determination sub-unit 1240 may obtain a candidate path with which produces the minimum value for the loss function from the storage 220. The path determination sub-unit 1240 may determine the optimized candidate path based on the obtained candidate samples. For example, the path determination sub-unit 1240 may determine sample features of the obtained candidate samples (e.g., candidate locations, candidate velocities, candidate accelerations) as features of the optimized candidate path.

It should be noted that the above description is provided for the purpose of illustration, and not intended to limit the scope of the present disclosure. For persons having ordinary skills in the art, two or more of the units may be combined into a single module, and any one of the units may be divided into two or more sub-units. Various variations and modifications may be conducted under the teaching of the present disclosure. However, those variations and modifications may not depart from the spirit and scope of this disclosure. For example, the minimum value determination sub-unit 1230 and the path determination sub-unit 1240 may be combined as a single sub-unit which may both determine the minimum value for the loss function and the optimized candidate. As another example, the optimized path determination unit 560 may include a storage unit (not shown) which may be used to store any information (e.g., intermediate results of each updates) associated with the loss function.

FIG. 13 is a flowchart illustrating an exemplary process and/or method for determining an optimized candidate path according to some embodiments of the present disclosure. The process and/or method 1300 may be executed by a processor in the autonomous vehicle 130 (e.g., the control unit 150). For example, the process and/or method 1300 may be implemented as a set of instructions (e.g., an application) stored in a non-transitory computer readable storage medium (e.g., the storage 220). The processor may execute the set of instructions and may accordingly be directed to perform the process and/or method 1300 via receiving and/or sending electronic signals.

In step 1310, the control unit 150 (e.g., the weight determination sub-unit 1210) may determine a plurality of weights for each of a plurality of indicators. In some embodiments, the plurality of indicators may be configured to evaluate a candidate. For example, the plurality of indicators may include a first indicator associated with locations, a second indicator associated with velocities, a third indicator associated with accelerations, and a fourth indicator associated with obstacles.

In some embodiments, the control unit 150 (e.g., the weight determination sub-unit 1210) may determine the plurality of weights based on environment information around the vehicle. For example, the control unit 150 (e.g., the weight determination sub-unit 1210) may determine the plurality of weights based on weather conditions. For another example, the control unit 150 (e.g., the weight determination sub-unit 1210) may determine the plurality of weights based on traffic conditions. As still another example, when moving on a curved road, the control unit 150 (e.g., the weight determination sub-unit 1210) may determine a higher weight for the second indicator relative to that on a straight road. In some embodiments, the control unit 150 (e.g., the weight determination sub-unit 1210) may determine the plurality of weights based on a user input. For example, the user may be very precautious and may input a higher weight for the fourth indicator to better avoid collisions. In some embodiments, the control unit 150 (e.g., the weight determination sub-unit 1210) may determine the plurality of weights based on a default setting. For example, the control unit 150 (e.g., the weight determination sub-unit 1210) may determine the plurality of weights based on the default settings of the autonomous vehicle 130. In some embodiments, the control unit 150 (e.g., the weight determination sub-unit 1210) may determine the plurality of weights based on a machine learning technique. The machine learning technique may include an artificial neural network, support vector machine (SVM), decision tree, random forest, or the like, or any combination thereof. For example, the control unit 150 (e.g., the weight determination sub-unit 1210) may determine the plurality of weights based on a machine learning technique.

In step 1320, the control unit 150 (e.g., the loss function determination sub-unit 1220) may determine a loss function based on the plurality of weights and the plurality of indicators. In some embodiments, the loss function may be configured to evaluate a candidate path. The reference path may include one or more reference samples. Each of the more or more reference samples may correspond to a candidate sample of the one or more candidate samples. The loss function may evaluate the candidate path determined by the one or more candidate samples based on kinematic differences and energy differences between each of the one or more candidate samples and each of the one or more corresponding reference samples. The kinematic differences and energy differences between each of the one or more candidate samples and each of the one or more corresponding reference samples may associated with sample features of the one or more candidate samples and the one or more reference samples. The sample features may include a velocity, an acceleration, a location (e.g., a coordinate), or the like, or a combination thereof.

Merely by way of example, the evaluation may be determined by the formula below:

J(Xₛ,Yₛ)=a₁*C_offset+a₂*C_vcl+a₃*C_acc+a₄*C_obs (5)

where J (Xₛ,Yₛ) may denote the loss function, (Xₛ,Yₛ) may represent a coordinate of a candidate location, a₁ may denote a first weight for the first indicator associated with locations, C_offset may denote the first indicator associated with locations, a₂ may denote a second weight for the second indicator associated with velocities, C_vcl may denote the second indicator associated with velocities, a₃ may denote a third weight for the third indicator associated with accelerations, C_acc may denote the third indicator associated with accelerations, a₄ may denote a fourth weight for the fourth indicator associated with obstacles, C_obs may denote the fourth indicator associated with obstacles.

In step 1330, the control unit 150 (e.g., the minimum value determination sub-unit 1230) may determine a minimum value for the loss function based on a gradient descent method. The gradient descent method may be a fast gradient method, a momentum method, etc. In some embodiments, the control unit 150 (e.g., the minimum value determination sub-unit 1230) may determine one or more parameters related to the gradient descent method. For example, the control unit 150 (e.g., the minimum value determination sub-unit 1230) may determine a gradient vector for the loss function. For another example, the control unit 150 (e.g., the minimum value determination sub-unit 1230) may determine a step size for the gradient descent method. In some embodiments, the control unit 150 (e.g., the minimum value determination sub-unit 1230) may approach the minimum value of the loss function by updating the sample features of the one or more candidate samples (e.g., a candidate location of a candidate sample). The updates of the sample features of the candidate samples may be along the negative direction of the gradient vector of the loss function. The kinematic differences and the energy difference between each two adjacent updates of the sample features of the candidate samples may be determined based on the step size. In some embodiments, the control unit 150 (e.g., the minimum value determination sub-unit 1230) may determine a convergence condition. The convergence condition may be configured to determine whether the updated candidate samples produce the minimum value for the loss function. For example, the control unit 150 (e.g., the minimum value determination sub-unit 1230) may determine the minimum value for the loss function when the convergence condition is met. The convergence condition may be determined based on a user input, or a default setting.

It should be noted that, when producing the minimum value for the loss function, the process and/or method 1300 may include one or more iterations. In each of the one or more iterations, the processor may generate an updated candidate path by updating the candidate samples.

In step 1340, the control unit 150 (e.g., the path determination sub-unit 1240) may determine an optimized path based on candidate path generating the minimum value for the loss function.

It should be noted that the above description is merely provided for the purposes of illustration, and not intended to limit the scope of the present disclosure. For persons having ordinary skills in the art, multiple variations and modifications may be made under the teachings of the present disclosure. However, those variations and modifications do not depart from the scope of the present disclosure. For example, one or more other optional steps (e.g., a storing step) may be added elsewhere in the exemplary process 1300. In the storing step, the control unit 150 may store intermediate results of each updates in any storage device (e.g., the storage 220) disclosed elsewhere in the present disclosure.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment,” “one embodiment,” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “block,” “module,” “engine,” “unit,” “component,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a software as a service (SaaS).

Furthermore, the recited order of processing elements or sequences, or the use of numbers, letters, or other designations, therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software-only solution—e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

1. A system, comprising:
a mounting structure configured to mount on a vehicle; and
a control module attached on the mounting structure, including
at least one storage medium storing a set of instructions,
an output port, and,
a microchip in connection with the at least one storage medium, wherein during operation, the microchip executing the set of instructions to:
obtain vehicle status information;
determine a reference path based on the vehicle status information;
determine a loss function incorporating the reference path, vehicle status information, and a candidate path;
obtain an optimized candidate path by optimizing the loss function;
send an electronic signal encoding the optimized candidate path to the output port.

2. The system of claim 1, further comprising:
a Gateway Module (GWM) electronically connected the control module to a Control Area Network (CAN);
the CAN electrically connected the GWM to at least one of:
an Engine Management System (EMS),
an Electric Power System (EPS),
an Electric Stability Control (ESC), and
a Steering Column Module (SCM).

3. The system of claim 1, wherein the reference path includes a reference sample; the candidate path includes a candidate sample; the loss function includes a first indicator; and,
the control module is further directed to:
determine the first indicator based on a difference between a reference location of the reference sample and a candidate location of the candidate sample.

4. The system of claim 1, wherein the reference path includes a reference sample; the candidate path includes a candidate sample; the loss function includes a second indicator; and,
the control module is further directed to:
determine the second indicator based on a difference between a reference velocity of the reference sample and a candidate velocity of the candidate sample.

5. The system of claim 1, wherein the reference path includes a reference sample; the candidate path includes a candidate sample; the loss function includes a third indicator; and,
the control module is further directed to:
determine the third indicator based on a difference between a reference acceleration of the reference sample and a candidate acceleration of the candidate sample.

6. The system of claim 1, wherein the loss function includes a fourth indicator; and,
the control module is further directed to:
obtain profile data of the vehicle;
obtain one or more locations of one or more obstacles around the vehicle;
determine one or more obstacle distances between the vehicle and the one or more obstacles;
determine the fourth indicator based on the one or more obstacle distances.

7. The system of claim 6, wherein value of the fourth indicator is inversely proportional to the one or more obstacle distances.

8. The system of claim 7, wherein the fourth indicator is expressed as:
$${\sum }_{k = 1}^{M} \frac{1}{{d}_{k} + E}$$
wherein the dₖ denotes the one or more obstacle distance, M denotes number of the one or more obstacles, and E denotes the profile data.

9. The system of claim 1, wherein the vehicle status information includes at least one of:
a driving direction of the vehicle, a velocity of the vehicle, an acceleration of the vehicle, or environment information around the vehicle.

10. The system of claim 1, wherein the loss function is optimized by gradient descent method.

11. A method, implemented on a control module, having a microchip, a storage medium, and an output, attached on a mounting structure of a vehicle, the method comprising:
obtaining, by the microchip, vehicle status information;
determining, by the microchip, a reference path based on the vehicle status information;
determining, by the microchip, a loss function incorporating the reference path, vehicle status information, and a candidate path;
obtaining, by the microchip, an optimized candidate path by optimizing the loss function;
sending, by the microchip, an electronic signal encoding the optimized candidate path to the output port.

12. The method of claim 11, wherein the reference path includes a reference sample; the candidate path includes a candidate sample; the loss function includes a first indicator; and,
the method further comprises:
determine the first indicator based on a difference between a reference location of the reference sample and a candidate location of the candidate sample.

13. The method of claim 11, wherein the reference path includes a reference sample; the candidate path includes a candidate sample; the loss function includes a second indicator; and,
the control module is further directed to:
determine the second indicator based on a difference between a reference velocity of the reference sample and a candidate velocity of the candidate sample.

14. The method of claim 11, wherein the reference path includes a reference sample; the candidate path includes a candidate sample; the loss function includes a third indicator; and,
the control module is further directed to:
determining, by the microchip, the third indicator based on a difference between a reference acceleration of the reference sample and a candidate acceleration of the candidate sample.

15. The method of claim 11, wherein the loss function includes a fourth indicator; and,
the method further comprises:
obtaining, by the microchip, profile data of the vehicle;
obtaining, by the microchip, one or more locations of one or more obstacles around the vehicle;
determining, by the microchip, one or more obstacle distances between the vehicle and the one or more obstacles;
determining, by the microchip, the fourth indicator based on the one or more obstacle distances.

16. The method of claim 15, wherein value of the fourth indicator is inversely proportional to the one or more obstacle distances.

17. The method of claim 16, wherein the fourth indicator is expressed as:
$${\sum }_{k = 1}^{M} \frac{1}{{d}_{k} + E}$$
wherein the dₖ denote the one or more obstacle distance, M denote number of the one or more obstacles, and E denote the profile data.

18. The method of claim 11, wherein the vehicle status information includeincludes at least one of:
a driving direction of the vehicle, a velocity of the vehicle, an acceleration of the vehicle, or environment information around the vehicle.

19. The method of claim 11, wherein the loss function is optimized by gradient descent method.

20. A non-transitory computer readable medium, comprising at least one set of instructions for determining a path for a vehicle, wherein when executed by at least one processor of an electronic terminal, the at least one set of instructions directs the at least one processor to perform acts of:
obtaining vehicle status information;
determining a reference path based on vehicle status information;
determining a loss function incorporating the reference path, vehicle status information, and a candidate path;
obtaining an optimized candidate path by optimizing the loss function;
sending an electronic signal encoding the optimized candidate path to the output port.
